(19) United States
(12) Patent Application Publication
(10) Pub. No.: US 2025/0114862 A1
(43) Pub. Date: Apr. 10, 2025

(54) METHOD FOR CORRECTING OPTICAL PATH LENGTH MEASUREMENT ERRORS OF A MEASUREMENT SCANNER AT A LASER PROCESSING OPTICAL UNIT

(71) Applicant: TRUMPF Laser GmbH, Schramberg (DE)

(72) Inventors: Jan-Patrick Hermani, Markgröningen (DE); Martin Stambke, Aichhalden (DE); Andreas Trost, Aichhalden (DE)

(21) Appl. No.: 18/989,000

(22) Filed: Dec. 20, 2024

Related U.S. Application Data
(63) Continuation of application No. PCT/EP2023/062708, filed on May 12, 2023.

(30) Foreign Application Priority Data
Jun. 29, 2022 (DE) 10 2022 116 153.6

(51) Int. Cl. B23K 26/082; B23K 26/03

(52) U.S. Cl. CPC B23K 26/082; B23K 26/032

(57) ABSTRACT

A method for correcting optical path length measurement errors of a measurement scanner at a laser processing optical unit includes incoupling a measurement beam of the measurement scanner for distance measurement purposes coaxially into a processing laser beam, moving the measurement beam laterally in an x-y plane over a workpiece in a vicinity of the processing laser beam, measuring distance values by the measurement scanner at different measurement points of the workpiece, and correcting the distance values in a z-direction by change values. The change values are obtained from calculated or previously known optical path lengths of the measurement beam at different selection points in the x-y plane.

### CROSS REFERENCE TO RELATED APPLICATIONS

This application is a continuation of International Application No. PCT/EP2023/062708 (WO 2024/002577 A1), filed on May 12, 2023, and claims benefit to German Patent Application No. DE 10 2022 116 153.6, filed on Jun. 29, 2022. The aforementioned applications are hereby incorporated by reference herein.

### FIELD

Embodiments of the present invention relate to a method for correcting optical path length measurement errors of a measurement scanner at a laser processing optical unit.

### BACKGROUND

In laser material processing, measurement scanners and in particular OCT measurement scanners are increasingly being used as distance-measuring sensors at laser processing apparatuses. These sensors make it possible to ensure that laser welding or marking takes place at the desired location. The measurement scanner scans the workpiece virtually coaxially with respect to the processing laser beam. In this case, the measurement beam may be deflected independently of the processing laser beam on the workpiece. The measurement values are evaluated by an image processing device, thereby enabling a visual check of the processing process.

If the measurement beam is laterally deflected relative to the beam axis of the processing laser beam, the optical path length of the measurement beam changes. One cause of the change in the optical path length is the geometric change in the path length owing to the adjustment of deflection angles of measurement scanner mirrors and/or mirrors of the laser processing optical unit. A further cause of the change in the optical path length of the measurement beam consists in varying glass passage lengths of the measurement beam when the measurement beam is moved through optical elements, for example an F-theta lens. Both causes are superimposed and lead to measurement errors. By way of example, if the measurement beam is moved along a line over a planar surface, then in the image generated by the measurement scanner, this line appears to be curved, even though it is straight.

If the measurement beam is deflected by deflection mirrors of the laser processing optical unit in the entire working area of the laser processing apparatus, this is referred to as a global change in the optical path length. That generally amounts to several millimetres. By contrast, if the measurement beam is deflected only by deflection mirrors of the measurement scanner in the vicinity of the processing laser beam, the change in the optical path length is referred to as a local change. The local change is of the order of less than 100 μm. For measurement systems which are intended to have a resolution of ±50 μm, a change in this magnitude range constitutes a problem.

### SUMMARY

Embodiments of the present invention provide a method for correcting optical path length measurement errors of a measurement scanner at a laser processing optical unit. The method includes incoupling a measurement beam of the measurement scanner for distance measurement purposes coaxially into a processing laser beam, moving the measurement beam laterally in an x-y plane over a workpiece in a vicinity of the processing laser beam, measuring distance values by the measurement scanner at different measurement points of the workpiece, and correcting the distance values in a z-direction by change values. The change values are obtained from calculated or previously known optical path lengths of the measurement beam at different selection points in the x-y plane.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show schematic illustrations of a laser processing optical unit with a measurement scanner for elucidating a global and local change in the optical path length of a measurement beam according to some embodiments;

FIG. 2 shows a block diagram of a correction of the local change in the optical path length from measurement values according to some embodiments; and

FIGS. 3a-3c show a schematic illustration of the correction of the local change in the optical path length on the basis of the example of a line scan, according to some embodiments.

### DETAILED DESCRIPTION

Embodiments of the present invention can eliminate or mitigate the influence of a local optical path length change on the measurement result of a measurement scanner at a laser processing optical unit.

According to some embodiments, a method for correcting optical path length measurement errors of a measurement scanner at a laser processing optical unit, wherein the measurement beam of the measurement scanner for distance measurement purposes is coaxially incoupled into the processing laser beam and is moved laterally in an x-y plane over a workpiece, which method is characterized in that the distance values measured by the measurement scanner at different scanning points of the workpiece are corrected in the z-direction by change values, wherein the change values are obtained from calculated or previously known optical path lengths of the measurement beam at different selection points in the x-y plane. Furthermore, the object is achieved by an image processing device of a laser processing apparatus according to independent claim 9.

This correction of the measurement values of the measurement scanner makes it possible to eliminate distortions of the image of the workpiece generated by the measurement scanner. After the correction, the distance data of the workpiece are accurate to a few micrometres, including in the z-direction. In this case, the correction of the image takes place directly after the recording of the measurement values.

The selection points correspond to different deflection angles of the measurement beam in the measurement scanner and/or in the laser processing optical unit. They are thus directly correlated with the positions of deflection mirrors in the measurement scanner and/or in the laser processing optical unit.

In a first method variant, the change values for the selection points can be stored in an image processing device of a laser processing apparatus. For this purpose, the image processing device can include various optical unit-specific correction data sets. With knowledge of the laser processing optical unit and the measurement scanner used, the corresponding correction data set can be selected and the change values can be taken therefrom and applied to the measurement values. Each correction data set contains change values of the optical path length for a multiplicity of angular positions of the deflection mirrors of the laser processing optical unit and of the measurement scanner, wherein these values can be stored in the form of a table.

In an alternative method variant, the change values can be obtained from a simulation of the optical system formed from the laser processing optical unit and the measurement scanner by a procedure in which the local change in the optical path length of the measurement beam at a plurality of selection points is calculated and a polynomial is determined therefrom, which polynomial contains the coordinates of the laser processing optical unit and of the measurement scanner and is used to calculate the optical path length of the measurement beam at the measurement points of the measurement scanner. This involves calculating the actual optical path length of the measurement beam at the respective measurement points during the measurement, and determining therefrom the change values for the measurement values.

In all method variants, at measurement points of the measurement beam which do not correspond to selection points, distance data can be corrected in the z-direction by change values which are calculated by interpolation from the change values of the closest selection points. It is therefore not necessary, in the method variant with stored change values, to determine these values for a very large number of points or, for determining the polynomial in the second method variant, to calculate the local change in the optical path length at a large number of selection points in order to achieve a sufficient accuracy of the measurement value correction.

In order to obtain an undistorted image of the workpiece, an image of the workpiece generated from the measurement data of the measurement scanner can be corrected in the z-direction using the change values by way of a geometric shearing method by means of the image processing device. In this case, the shearing for the image can preferably be carried out column by column by virtue of each column being displaced in the z-direction by the change value of the optical path length.

In order to attain a correction result that is as accurate as possible, the optical path length calculation is preferably carried out taking account of the geometric set-up of the laser processing optical unit, the optical elements used in the laser processing optical unit and the measurement scanner, and the materials of said optical elements, i.e. taking account of all parameters relevant to the optical path length.

Exemplary embodiments of the method are explained in greater detail below with reference to the drawings.

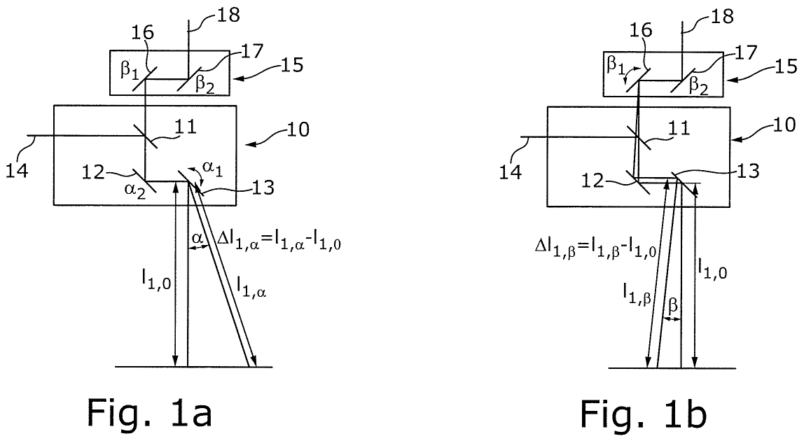

FIG. 1 schematically shows a laser processing optical unit 10 comprising three deflection mirrors 11, 12 and 13 for a processing laser beam 14, and a measurement scanner 15 comprising two deflection mirrors 16, 17 for a measurement beam 18. The deflection mirror 11 is fixed in place, while the deflection mirrors 12, 13 are adjustable. The measurement beam 18 is coaxially incoupled into the processing laser beam 14 via the deflection mirror 11.

In FIG. 1a, the measurement beam 18 together with the processing laser beam 14 is deflected by an angle α relative to the perpendicular by the deflection mirror 13 by virtue of the deflection mirror 13 being adjusted by an angle α₁. This has the effect that the optical path length I_{1,0} of the measurement beam 18 changes to a longer path length I_{1,α}. The change value amounts to ΔI_{1,α}=I_{1,α}−I_{1,0} and is referred to as a global change in the optical path length. That generally amounts to a few millimetres.

In FIG. 1b, by contrast, the measurement beam 18 is deflected by an angle β relative to the perpendicular by the deflection mirror 16 in the measurement scanner 15 by virtue of the deflection mirror 16 being adjusted by an angle β₁. This deflection has the effect that the optical path length I_{1,0} of the measurement beam 18 changes to I_{1,β}, wherein the change value amounts to ΔI_{1,β}=I_{1,β}−I_{1,0}. This change is referred to as a local change in the optical path length and is significantly smaller than the global change in the optical path length and is of the order of 100 μm.

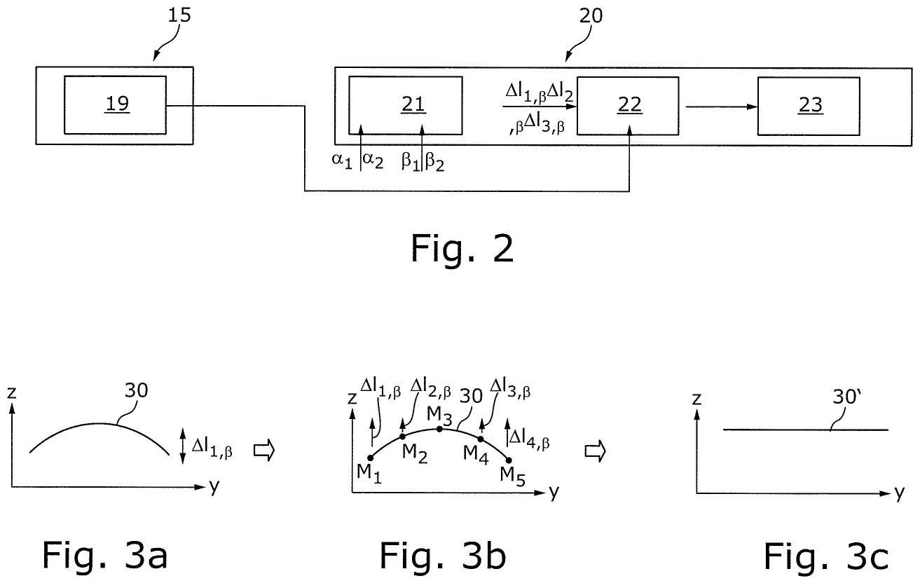

The method shown in FIG. 2 eliminates the influence of the local change in the optical path length of the measurement beam 18 on the measurement values of the measurement scanner 15. The block diagram schematically shows the measurement scanner 15 comprising a control device 19 for the deflection mirrors 16, 17 for the measurement beam 18, and also an image processing device 20. The image processing device 20 has a correction data set 21 for the optical path length, a computing unit 22 for calculating the corrected measurement values, and also a memory 23 for the corrected measurement values. With the aid of the known angular positions α₁, α₂ of the deflection mirrors 13 and 12 of the laser processing optical unit 10 and the angular positions β₁, β₂ of the deflection mirrors 16 and 17 of the measurement scanner 15, the change values ΔI_{1,β}, ΔI_{2,β}, ΔI_{3,β} . . . of the optical path length can be read out from the correction data set 21 and, in the computing unit, can be applied to the measurement values from a memory of a control device 19 of the measurement scanner 15. The corrected measurement values resulting from this calculation are subsequently stored in the memory 23 of the image processing device. An undistorted image of a workpiece to be processed by the processing laser beam 14 can be generated from the corrected measurement values.

FIGS. 3 a-c illustrate this on the basis of the example of a line scan by the measurement scanner 15 in the y-direction. FIG. 3a illustrates the image of the line 30 without correction of the measurement values of the measurement scanner 15. The actually straight line appears to be curved in the z-direction since the change in the optical path length of the measurement beam 18 is not taken into account. The greatest curvature is at the end points of the line 30 since that is where the measurement beam 18 experiences its greatest deflection.

FIG. 3b clarifies the correction of the measurement values captured by the measurement scanner 15, which in the example illustrated were ascertained at five measurement points M1 to M5 of the line 30 through the measurement beam 18. In this case, the measurement points M1 to M5 are selection points on the line 30. At the measurement point M3, the measurement beam 18 does not experience any deflection. The measurement value at the measurement point M3 is correct, without any change in the optical path length, and is not corrected. At the other measurement points M1, M2, M4 and M5, by contrast, the measurement values of the line 30 are corrected in the z-direction by the change values ΔI_{1,β}, ΔI_{2,β}, ΔI_{3,β}, ΔI_{4,β} of the optical path length of the measurement beam 18. The result is shown in FIG. 3c: after the correction of the measurement values of the line 30, the latter acquires a straight course in accordance with a straight line 30′, as shown in FIG. 3c. The z-coordinates of all the measurement points M1 to M5 are identical after the correction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for correcting optical path length measurement errors of a measurement scanner at a laser processing optical unit, the method comprising:
incoupling a measurement beam of the measurement scanner for distance measurement purposes coaxially into a processing laser beam,
moving the measurement beam laterally in an x-y plane over a workpiece in a vicinity of the processing laser beam,
measuring distance values by the measurement scanner at different measurement points of the workpiece, and
correcting the distance values in a z-direction by change values, wherein the change values are obtained from calculated or previously known optical path lengths of the measurement beam at different selection points in the x-y plane.

2. The method according to claim 1, wherein the selection points correspond to different deflection angles of the measurement beam in the measurement scanner and/or in the laser processing optical unit.

3. The method according to claim 1, wherein the change values for the selection points are stored in an image processing device of a laser processing apparatus.

4. The method according to claim 1, wherein the change values are obtained from a simulation of an optical system formed from the laser processing optical unit and the measurement scanner by a procedure in which a local change in a respective optical path length of the measurement beam at the selection points is calculated and a polynomial is determined therefrom, wherein the polynomial contains coordinates of the laser processing optical unit and of the measurement scanner and is used to calculate the respective optical path length of the measurement beam at the measurement points of the measurement scanner.

5. The method according to claim 1, wherein at any measurement points of the measurement beam which do not correspond to the selection points, the distance values are corrected in the z-direction by the change values which are calculated by interpolation from the change values of closest selection points.

6. The method according to claim 1, further comprising correcting an image of the workpiece generated from measurement data of the measurement scanner in the z-direction using the change values by using a shearing method by an image processing device.

7. The method according to claim 6, wherein the shearing method for the image is carried out column by column by virtue of each column being displaced in the z-direction by the change value of the optical path length.

8. The method according to claim 1, wherein the respective optical path length is calculated taking account of a geometric set-up of the laser processing optical unit, optical elements used in the laser processing optical unit and the measurement scanner, and materials of the optical elements.

9. An image processing device of a laser processing apparatus for performing the method according to claim 1.
